(19) United States
(12) Patent Application Publication
(10) Pub. No.: US 2018/0186255 A1
(43) Pub. Date: Jul. 5, 2018

(54) CAR SEAT ASSEMBLY

(71) Applicant: Jeffrey Gomez, New York, NY (US)

(72) Inventor: Jeffrey Gomez, New York, NY (US)

(21) Appl. No.: 15/397,826

(22) Filed: Jan. 4, 2017

(51) Int. Cl. B60N 2/28; A47D 5/00

(52) U.S. Cl. CPC B60N 2/2875; B60N 2/2803; A47D 5/00

(57) ABSTRACT

A car seat assembly includes a base that may be positioned on a seat in a vehicle. A car seat is rotatably coupled to the base and a child may be seated therein. The car seat has a chair and a backrest and the child sits in the chair. The chair is selectively rotated in a first position such that the chair is oriented collinear with the seat in the vehicle. The chair is selectively rotated into a second position such that the chair is oriented orthogonally with respect to the seat in the vehicle to facilitate an adult to access the child.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to seat devices and more particularly pertains to a new seat device for selectively positioning a child for diaper changing when the child is seated in a vehicle.

### BRIEF SUMMARY OF THE INVENTION

An embodiment of the disclosure meets the needs presented above by generally comprising a base that may be positioned on a seat in a vehicle. A car seat is rotatably coupled to the base and a child may be seated therein. The car seat has a chair and a backrest and the child sits in the chair. The chair is selectively rotated in a first position such that the chair is oriented collinear with the seat in the vehicle. The chair is selectively rotated into a second position such that the chair is oriented orthogonally with respect to the seat in the vehicle to facilitate an adult to access the child.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a car seat assembly according to an embodiment of the disclosure.

FIG. 2 is a right side view of an embodiment of the disclosure.

FIG. 3 is a bottom perspective view of an embodiment of the disclosure.

FIG. 4 is a top view of an embodiment of the disclosure.

FIG. 5 is a perspective in-use view of an embodiment of the disclosure showing a chair in a second position.

### DETAILED DESCRIPTION OF THE INVENTION

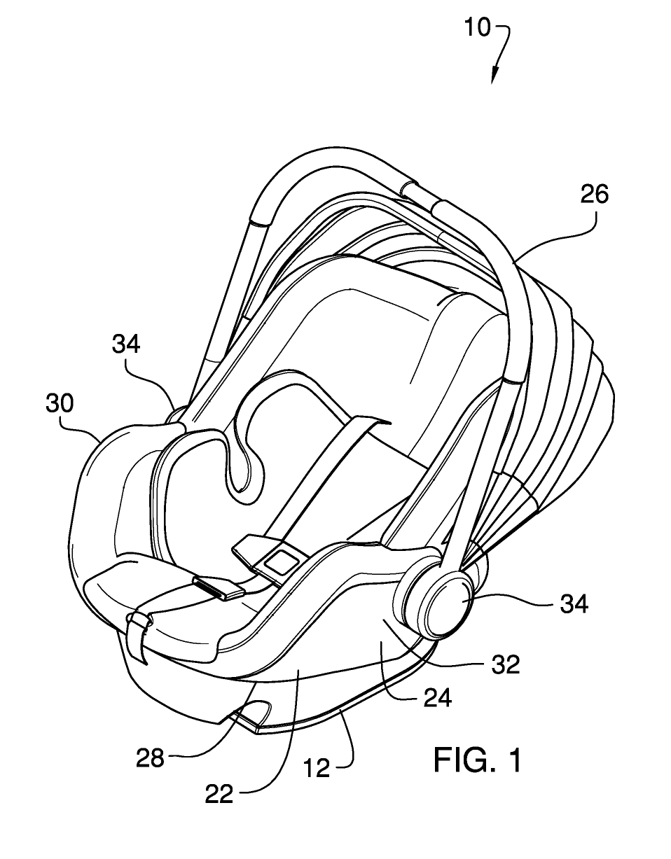

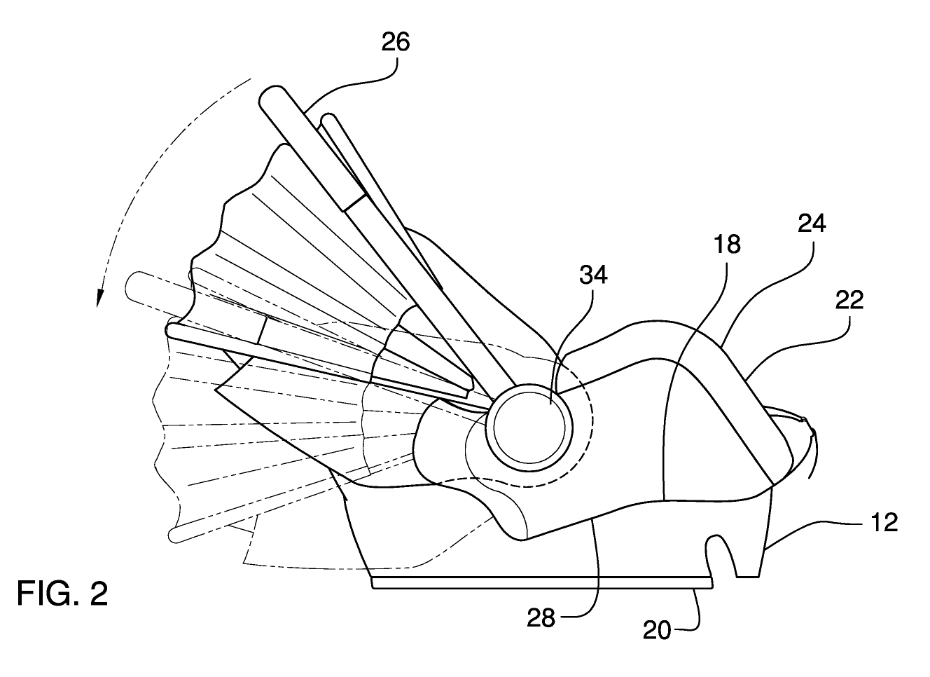

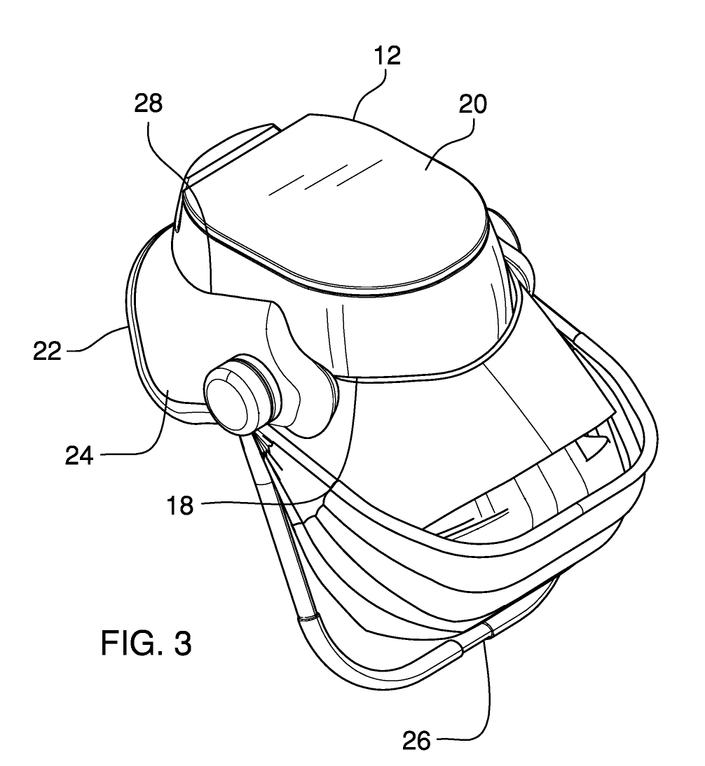

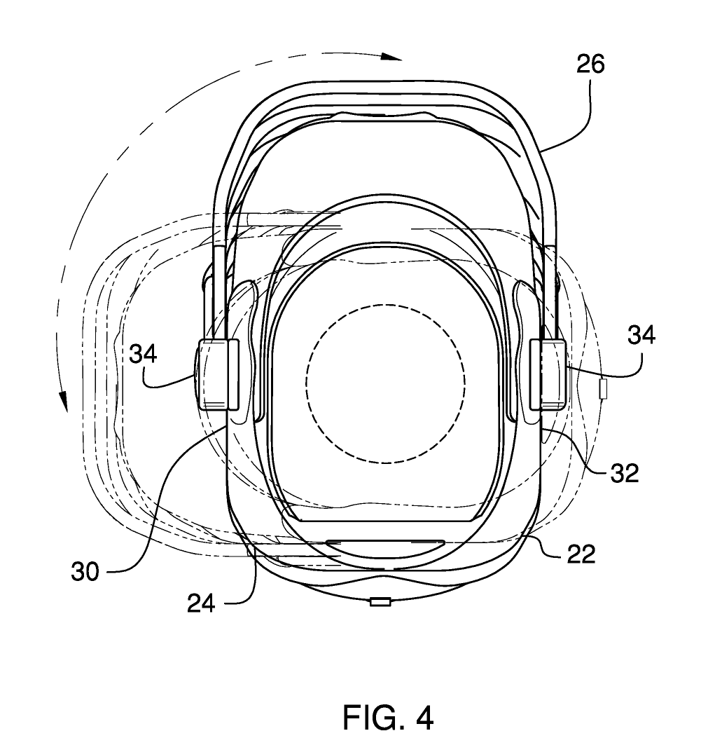

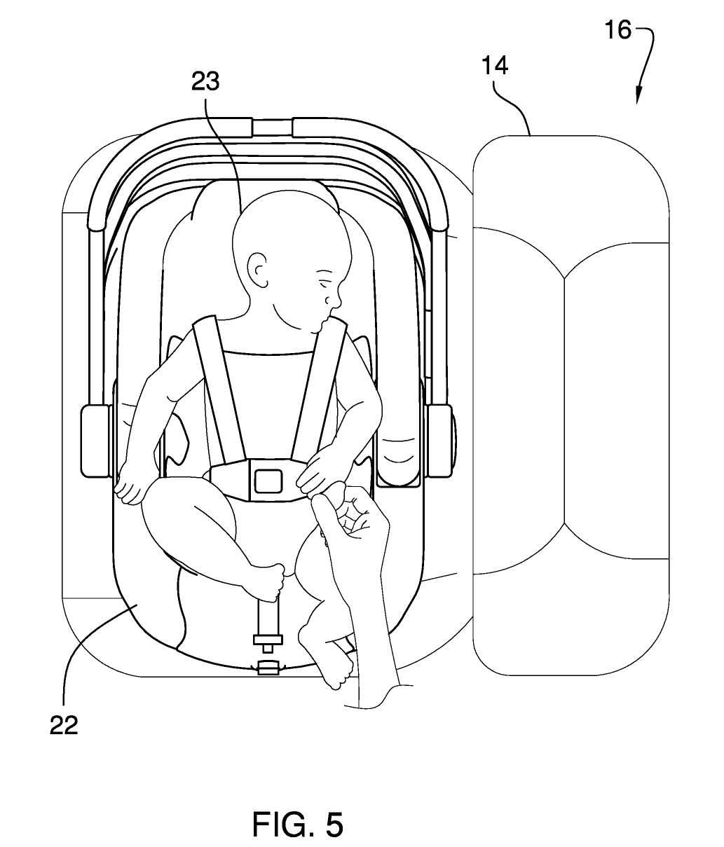

With reference now to the drawings, and in particular to FIGS. 1 through 5 thereof, a new seat device embodying the principles and concepts of an embodiment of the disclosure and generally designated by the reference numeral 10 will be described.

As best illustrated in FIGS. 1 through 5, the car seat assembly 10 generally comprises a base 12 that may be positioned on a seat 14 in a vehicle 16. The vehicle 16 may be a passenger vehicle 16 or the like. The base 12 has a top side 18 and a bottom side 20 and the bottom side 20 abuts the seat 14. A car seat 22 is rotatably coupled to the base 12 and the car seat 22 may have a child 23 seated therein. The car seat 22 may be a child car seat or the like that includes s plurality of belts and buckles to restrain the child 23 in the car seat 22.

The car seat 22 has a chair 24 and a backrest 26. The chair 24 has a lower side 28, a first lateral side 30 and a second lateral side 32. The lower side 28 is rotatably coupled to the top side 18 of the base 12 and the child 23 is selectively positioned in the chair 24. The chair 24 is selectively rotated in a first position such that the chair 24 is oriented collinear with the seat 14 in the vehicle 16. In this way the chair 24 is positioned to orient the child 23 in a manner that is consistent with vehicle safety guidelines. The chair 24 is selectively rotated into a second position such that the chair 24 is oriented orthogonally with respect to the seat 14 in the vehicle 16. In this way an adult may access the child 23 from a lateral position with respect to the seat 14 in the vehicle 16. Moreover, the chair 24 may mechanically engage the base 12 to releasably retain the chair 24 in the first position and the second position through the use of a spring loaded locking mechanism or the like.

The backrest 26 is hingedly coupled to each of the first lateral side 30 and the second lateral side 32 to define a pair of hinge points 34 on the backrest 26. The hinge points 34 may comprise mechanical locks, friction plates or any other mechanical means of facilitating the backrest 26 to be positioned at a selected angle with respect to the chair 24. The backrest 26 is selectively positioned in an upright first position. In this way the backrest 26 retains the child 23 in a seated position. The backrest 26 is selectively positioned in a reclined position. In this way the backrest 26 retains the child 23 in a prone position thereby facilitating a diaper on the child 23 to be changed.

In use, the base 12 and the car seat 22 are positioned on the seat 14 in the vehicle 16. The child 23 is selectively positioned and secured in the car seat 22 in the convention of child car seats. The chair 24 is rotated into the first position when the vehicle 16 is being driven such that the car seat 22 promotes safety of the child 23. The chair 24 is rotated into the second position when the vehicle 16 is not being driven and the child 23 needs a diaper change. Thus, the child 23 is accessible from a lateral position with respect to the seat 14 in vehicle 16. The backrest 26 is positioned into the reclined position to enhance the child 23's positioning with respect to changing a diaper. In this way the base 12 and the car seat 22 facilitate the child 23's diaper to be changed without removing the child 23 from the vehicle 16. The backrest 26 is positioned in the upright position and the chair 24 is rotated into the first position when the diaper has been changed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A car seat assembly being selectively positioned between an upright position and a reclined position wherein said assembly is configured to facilitate diapers to be changed on a child, said assembly comprising:
a base being configured to be positioned on a seat in a vehicle, said base has a top side and a bottom side, said bottom side being configured to abut the seat, said base being planar, said base having a curved rear edge, said base having a straight forward edge opposite said curved rear edge; and
a car seat being rotatably coupled to said base wherein said car seat is configured to have a child seated therein, said car seat having a chair and a backrest, said chair being configured to have the child sitting therein, said chair being selectively rotated in a first position wherein said chair is configured to be oriented collinear with the seat in the vehicle, said chair being selectively rotated into a second position wherein said chair is configured to be oriented orthogonally with respect to the seat in the vehicle thereby facilitating an adult to access the child, said chair having a lateral slot extending across said chair, said lateral slot being positioned adjacent to said straight forward edge when said car seat is in said first position.

2. (canceled)

3. The assembly according to claim 1, wherein chair has a lower side, a first lateral side and a second lateral side, said lower side being rotatably coupled to said top side of said base.

4. The assembly according to claim 1, wherein:
said chair has a first lateral side and a second lateral side; and
said backrest is hingedly coupled to each of said first lateral side and said second lateral side to define a pair of hinge points on said backrest.

5. The assembly according to claim 4, wherein said backrest is selectively positioned in an upright first position wherein said backrest is configured to retain the child in a seated position.

6. The assembly according to claim 4, further comprising said backrest is selectively positioned in a reclined position wherein said backrest is configured to retain the child in a prone position thereby facilitating a diaper on the child to be changed.

7. A car seat assembly being selectively positioned between an upright position and a reclined position wherein said assembly is configured to facilitate diapers to be changed on a child, said assembly comprising:
a base being configured to be positioned on a seat in a vehicle, said base having a top side and a bottom side, said bottom side being configured to abut the seat said base being planar, said base having a curved rear edge, said base having a straight forward edge opposite said curved rear edge; and
a car seat being rotatably coupled to said base wherein said car seat is configured to have a child seated therein, said car seat having a chair and a backrest, chair having a lower side, a first lateral side and a second lateral side, said lower side being rotatably coupled to said top side of said base, said chair being configured to have the child sitting therein, said chair being selectively rotated in a first position wherein said chair is configured to be oriented collinear with the seat in the vehicle, said chair being selectively rotated into a second position wherein said chair is configured to be oriented orthogonally with respect to the seat in the vehicle thereby facilitating an adult to access the child, said backrest being hingedly coupled to each of said first lateral side and said second lateral side to define a pair of hinge points on said backrest, said backrest being selectively positioned in a upright first position wherein said backrest is configured to retain the child in a seated position, said backrest being selectively positioned in a reclined position wherein said backrest is configured to retain the child in a prone position thereby facilitating a diaper on the child to be changed, said chair having a lateral slot extending across said chair, said lateral slot being positioned adjacent to said straight forward edge when said car seat is in said first position.
